(19) United States
(12) Patent Application Publication
(10) Pub. No.: US 2009/0177129 A1
(43) Pub. Date: Jul. 9, 2009

(54) WRIST MASSAGER

(75) Inventors: Chung Man Chan, Hong Kong (HK); Ken Chung Hang Leung, Hong Kong (HK); Lok Ting Wong, Hong Kong (HK); Ka Lun Fan, Hong Kong (HK); Ching Ching Cheung, Hong Kong (HK); Hung Keung Tse, Hong Kong (HK)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: AVITON CARE LIMITED, Kwun Tong (HK)

(21) Appl. No.: 11/969,240

(22) Filed: Jan. 4, 2008

(51) Int. Cl. A61H 15/00

(52) U.S. Cl. 601/112; 601/134

(57) ABSTRACT

The present invention is a wrist massager particularly applying to the wrist part of human being adopting acupressure theory of Traditional Chinese Medicine (TCM) in order to circumvent wrist musculoskeletal disorders (MSDs). It comprises a wrist band operably engaged a control panel 4 and a motorised cushion housing 2 with protruding massage means3. The wrist band added with size-adjustable mechanism is designed for users to fit their wrist into the massager comfortably and firmly. It contains a motor/motors to produce vibration and deliver reciprocating and/or rotary massaging effect via the massage means3. Alternatively, the wrist massager is a plate 8 with planar bottom and a housing placed on the surface of the plate 8. A detachable massaging means protrudes from the surface of the said housing.

### FIELD OF THE INVENTION

The present invention relates generally to massaging machines, and relates more particularly to a wrist massager circumventing MSDs by adopting TCM theory.

### BACKGROUND OF THE INVENTION

Massaging machines are more and more popular nowadays as a mean for relaxing and muscular pain releasing.

Acupuncture is commonly recognized to have originated in China and is most commonly associated with Traditional Chinese Medicine (TCM). U.S. Pat. No. 4,479,495 (Oct. 30, 1984) describes an acupressure point stimulator device applying the acupuncture art at Pericardium 6, or the traditional Chinese appellation Neiguan and at Spleen Six, or the traditional Chinese appellation Sanyinjiao. Also, U.S. Pat. No. 7,228,103 (May 8, 2001) describes another acupressure device applying to Neiguan point or PC6.

Neiguan, PC6 is an acupoint, a point of the skin that is stimulated, in practice of acupuncture. It is located on the wrist, along the pericardium meridian. The use of Neiguan, PC6 for relieving nausea and vomiting is known. Students and white-collars attended to desk-work on long hour basis. As the advent of computer and internet, more people work, play and learn by using computer. The prolonged sedentary gesture increases the burdens of muscles, tendons and soft tissues on wrist joints. Thereby, it increases the susceptibility of people to musculoskeletal disorders (MSDs), particularly to the wrist part. Carpal Tunnel Syndrome (CTS) is one of the common MSDs on wrist. The carpal tunnel is a channel in the wrist volar, with several tendons and median nerve passing through. The prolonged sedentary gesture adds chances of swelling and rising pressure inside the said channel, causing CTS accordingly. More and more people suffered from pain and paresthesias, such as prinkling, itching, fatique in the area of median nerve in and along the wrist.

According to US Department of Labour, CTS affected over 8 million Americans in 1999. And, the risk of developing CTS is increasing and widespreading. Certain data suggests women are 3 times more susceptible to develop CTS than men as the carpal tunnel may be smaller in women than in men.

U.S. Pat. No. 7,232,976 (Jun. 19, 2007) describes a therapeutic mouse pad massaging a bottom surface of a person's wrist. It has heating mechanism and oscillating mechanism.

People suffered MSDs demand a device targeting the points along the wrist which are most tiring, fatique, stretched. These people require well—targeted acupressure and immediate soothing effect, and the current devices are applying acupressure to relieve ailments, other than MSDs, or ineffectively applying acupressure to a mass which may not be the focused areas where the meridian channel and blood flow blocks.

Chinese literatures showed that acupressure treatment is effective in soothing wrist MSDs by unblocking meridian channels and activating blood flow. One acupoint selected commonly by TCM practitioners is Daling, PC7 18 on wrist volar. There is further a combination of acupoints used by TCM practitioners. In addition to Neiguan, PC6 17, they are Daling, PC7 18, Yangchi, SJ4 19 and Waiguan, SJ5 20. Daling, PC7 18 is proximate to Neiguan, PC 6 17 and located along the pericardium meridian. Yangchi, SJ4 19 and Waiguan, SJ5 20 are located along the triple burner meridian on wrist dorsum.

### SUMMARY OF THE INVENTION

The device of the present invention is designed to provide simultaneous acupressure to Neiguan, PC6 17, Daling, PC7 18, Yangchi, SJ4 19 and Waiguan, SJ5 20. In the preferred embodiment, the massage means3 provides acupressure to a combination of said acupoints, or alternatively to the said Daling, PC7 18. It comprises a cushion housing, a strap 1, a driving means, a control panel 4 and a massage means3. In one method of use, the device is worn on the wrist and energized to provide simultaneous and targeted acupressure on the said combination of acupoints. Alternatively, the device focuses the acupressure on Daling, PC7 18 and is detachable from with a mouse pad.

### BRIEF DESCRIPTION OF THE DRAWINGS

FIG. 1 is the perspective view of one embodiment of the present invention with a closed strap 1.

FIG. 2 is the top view of one embodiment of the present invention in FIG. 1 illustrating the control panel 4.

FIG. 3 is the side view of one embodiment of the present invention in FIG. 1 illustrating the two cushion housing 2 along the strap 1.

FIG. 4 is the block diagram of the operation flow of one embodiment of the present invention in FIG. 1.

FIG. 5 is the perspective view of one embodiment of the present invention with a plate 8 supporting a housing incorporating the massage means 3.

FIG. 6 is the top view of one embodiment of the present invention in FIG. 5.

FIG. 7a is the top view of one embodiment of the present invention in FIG. 5 (plate 8 only, without the massager).

FIG. 7b is the bottom view of one embodiment of the present invention in FIG. 5 showing the cinching strap 16.

FIG. 8a is the top view of one embodiment of the present invention in FIG. 5 illustrating the standalone massager detached from the plate 8 using cam wheel.

FIG. 8b is the top view of one embodiment of the present invention in FIG. 5 illustrating the standalone massager detached from the plate 8 using rotation disc.

FIG. 9 is the block diagram of the operation flow of one embodiment of the present invention in FIG. 5.

FIG. 10 is a diagrammatic illustration of the Neiguan, PC6 17 and Daling, PC7 18.

FIG. 11 is a diagrammatic illustration of Yangchi, SJ4 19 and Waiguan, SJ5 20.

### DETAILED DESCRIPTION OF THE PREFERRED EMBODIMENTS

The following detailed description refers to the accompanying drawings. Wherever possible, the same reference numbers are used in the drawings and the following description to refer to the same or similar parts. While several exemplary embodiments and features of the present invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the present invention. Instead, the proper scope of the present invention is defined by the appended claims.

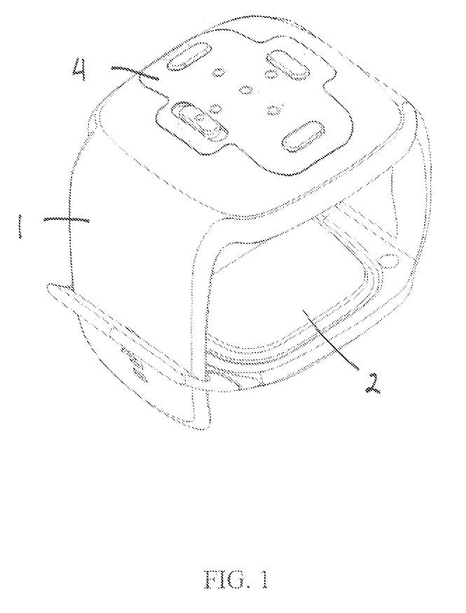

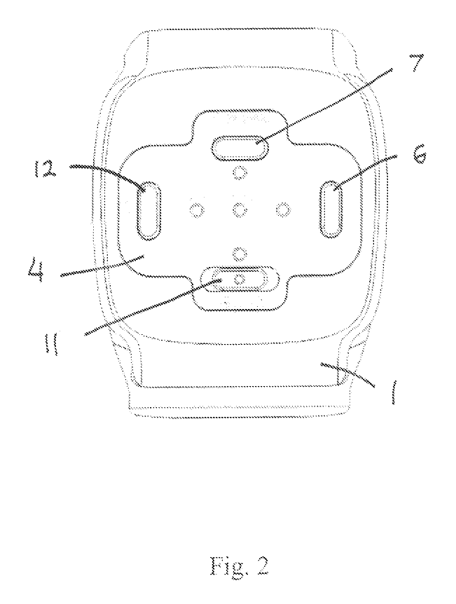

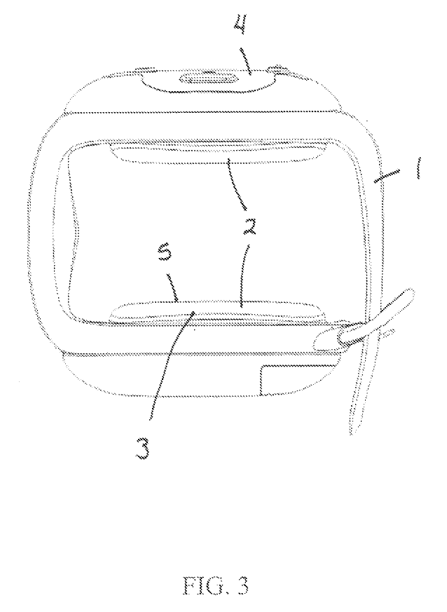

FIGS. 1, 2, 3 are the perspective view, top view and side view respectively of one embodiment of the present invention which comprises a strap 1, two cushion housings2, a massage means3, a driving means (not shown), and a control panel 4.

In the preferred embodiment, the strap 1 has a buckle or lock and release mechanism allowing the user to adjust the circumference of the strap 1 when encircling the wrist of the user. The strap holds two cushion housings 2 and a control panel 4. In one embodiment of the present invention, a first cushion housing 2 and a control panel 4 are intercalated on two sides of a portion of a strap when the second cushion housing 2 is located apart from the first cushion housing, so that the second cushion housing is placed against the wrist volar, where Daling, PC7 18 and Neiguan, PC6 17 situate, and the second cushion housing 2 is placed against the wrist dorsum where Yangchi, SJ4 19 and Waiguan, SJ5 20 situate. When the strap closes, control panel 4 faces upward to the eyes of user.

The cushion housing 2 is covered by a membrane 5 adapted for placement against the skin. In preferred embodiment, the said membrane 5 is fabricated of soft and elastic material and the said cushion housings 2 are fabricated of a compressable and resilient material. The said cushion housing 2 has a hollow cavity, wherein the massage means 3 and driving means are accommodated.

In preferred embodiment, the messaging means are four 3-rollers rotation disc 14. The rotation disc 14 are disposed in the housing 2 proximate to the membrane 5 and biased towards the membrane 5 creating localized outwardly deformations in the membrane 5 when in contact with each of the said acupoints of the wrist. The rotation disc 14 are provided in the hollow cavity of each of the said cushion housings 2 and to provide acupressure on specified acupoints of the wrist volar, namely Daling, PC7 18 and Neiguan, PC6 17 and the other specified acupoints of the wrist dorsum, namely Yangchi, SJ4 19 and Waiguan, SJ5 20. Alternatively, the massaging means can be a cam wheel 15.

The messaging means 3 are operably coupled to the driving means equipped with a DC powered motor with proper gearing mechanism. Such driving mechanism drives the rotation and reciprocation of the massaging means. Alternatively, the driving mechanism comprises a weighted concentric means (not shown) and thereby making the massaging means vibrating.

In the preferred embodiment, a control panel 4 is placed on an outer surface of the strap 1 and disposed at the top side of the wrist dorsum when the strap 1 closing and forming a loop and encircling around the wrist. The said control panel 4 comprises an On/Off button 11 to control the power application and a speed button 12 to control the massage speed. In preferred embodiment, the said control panel 4 also has a button 6 controlling the vibration mode and a start/stop button 7 to control the commencement and stop of the massaging mechanism.

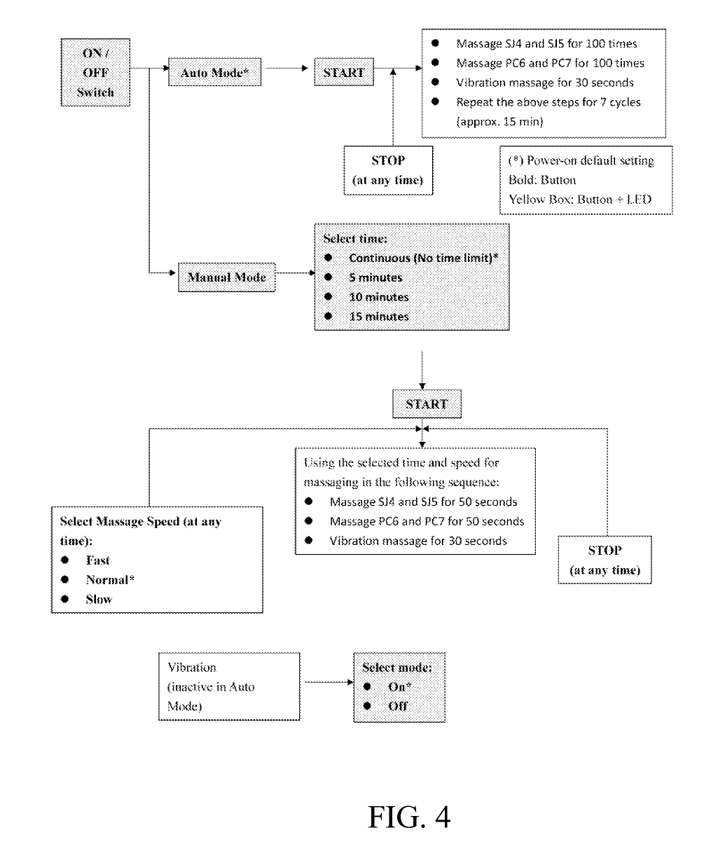

As illustrated in FIG. 4, the user first turns on the present invention by momentary pressing the on/off button 11 and gives instruction to the present invention to commence acupressure massaging by momentary pressing the start/stop button 7. In preferred embodiment, the present invention is adapted to massage Yangchi, SJ4 19 and Waiguan, SJ5 20 for 100 times and Daling, PC7 18 and Neiguan, PC6 17 for 100 times by rotation mode massage and then activate the vibration mode massage for 30 seconds. The foregoing auto mode massage repeats for 7 times for approximately 15 minutes. Alternatively, the user may manually operate the present invention. The user may select different massaging speed by pressing a speed button 12, thereby preferably selecting a fast mode, a normal level and a slow mode. The present invention is further adapted to have a duration button, preferably the user may thereby select continuous massage, or 5 minutes, 10 minutes or 15 minutes massage. In the aforesaid duration, the present invention is adapted to massage Yangchi, SJ4 19 and Waiguan, SJ5 20 for 50 seconds and Daling, PC7 18 and Neiguan, PC6 17 for 50 seconds by rotation mode massage and then activate the vibration mode massage for 30 seconds. The foregoing auto and manual modes respectively may be stopped by the user by pressing start/stop button 7 anytime. It may provide indicator lights, by means of LED, indicating to the user the instructed speed. Further, the user may interchangeable select a specified massage mode of vibration by momentary pressing the massaging mode button 6.

In preferred embodiment, this device provides an automatic stop if acupressure massage runs for 15 minutes. For the normal speed module, the predetermined pace of rotation and vibration for 15 minutes amounts to 100 times acupressure on each of the acupoints.

In one embodiment, this device further includes a LCD display module. The LCD display module is disposed in the centre of the control panel. The said LCD display module is adapted to display time and date with alarm function, digital numeric and alphabetical characters, graphical animations, massager operation status, massager mode selection status (rotation or vibration), massage speed selection status (fast, normal or slow), massager duration selection status (continuous or, 5, 10 or 15 minutes), massage time countdown and massage program selection status (auto or manual mode).

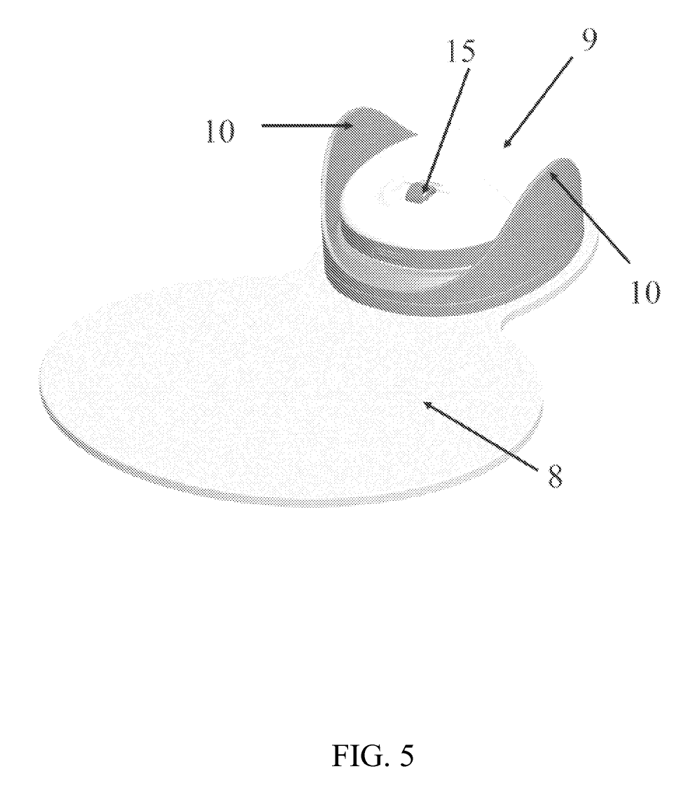

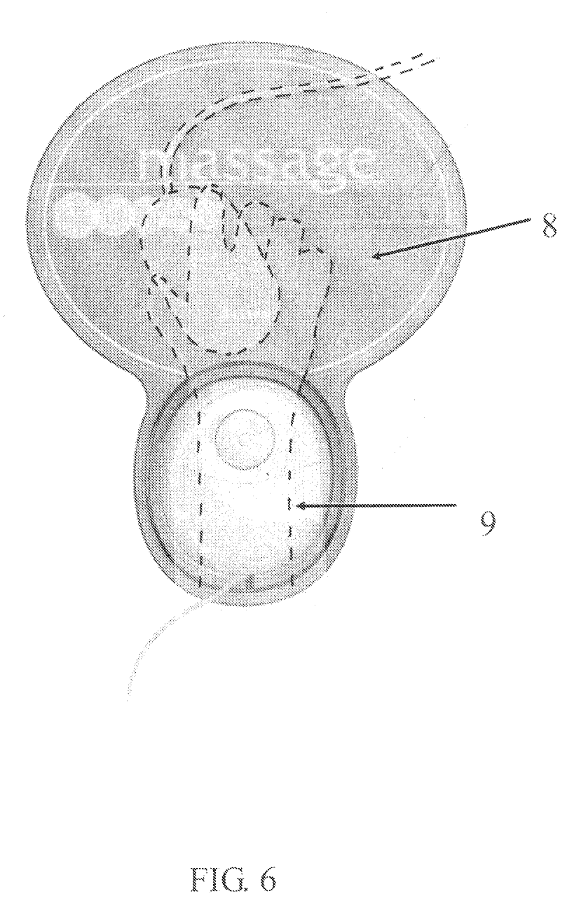

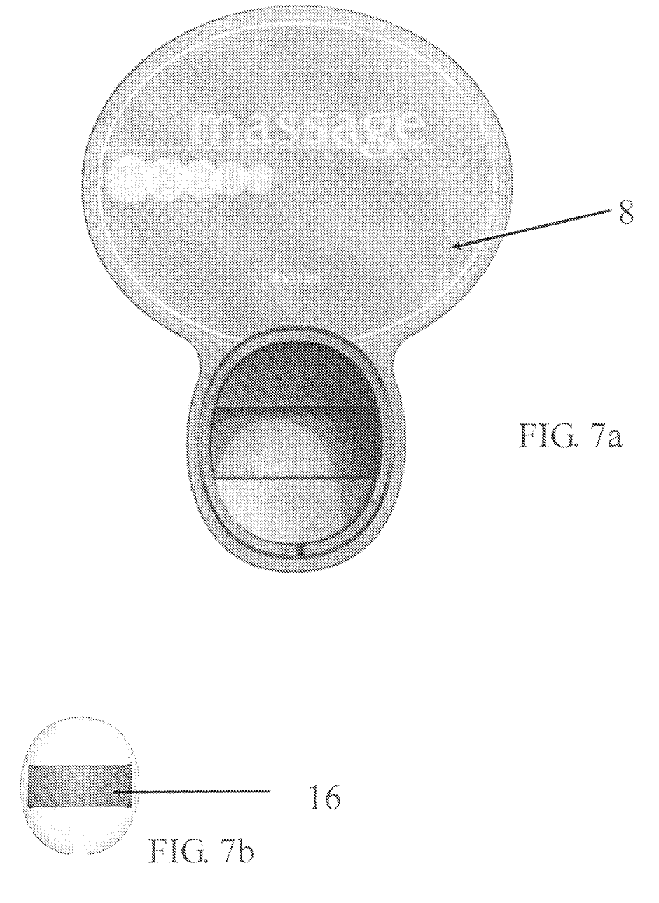

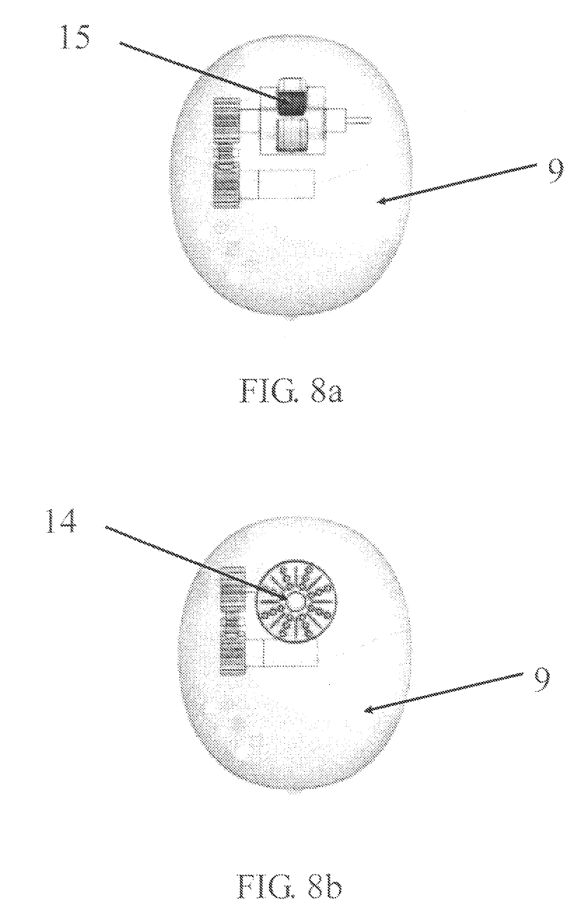

FIGS. 5, 6, 7a, 7b, 8a and 8b and 9 illustrate an alternative embodiment of this invention. This invention comprises a plate 8 for supporting a housing 9 against the wrist volar. The said housing 9 is fabricated of a hard and resilient material. The said housing 9 further has a hollow cavity accommodating the massage means3 and the driving means (not shown). The said massage means3 protrudes from a proximal edge of the top side of the said housing 9 and to provide acupressure on an acupoint on wrist volar, namely Daling, PC7 18;

The control means of the alternative embodiment comprises a computer program controlling the operation of the present invention. In the preferred embodiment, the user gives instruction to a computer, operably connecting to the massage means3 through USB (not shown). Such instructions are On/Off power application, the massage speed and duration and records. Other functions like work hour counter and email alert could also be communicated to the user upon receiving signal from the computer by a specified pattern of vibration or rotation by the massage means3.

In the preferred embodiment, this present invention provides two flanges 10 firmly conjoined to the surface of a proximal edge of the said plate 8. Each of the two flanges 10 has a dome shape suitably sized for fitting a wrist of a person. The said flanges 10 stand at a distance in between and are adapted to suitably fit the said housing 9 and a wrist of an user resting on the said housing 9.

Further, the said housing 9 carrying the massaging means is provided as a detachable part from the plate 8. The user can then use it as a hand held massaging device. In the preferred embodiment, the said housing 9 further comprises a cinching band or strap 16 firmly attached, or in the alternative, attached with and being detachable from the lateral sides of the said housing. The said strap 16 is adapted to hold the said housing to the wrist of an user. It can be made of soft or elastic materials facilitating firm and comfortable holding.

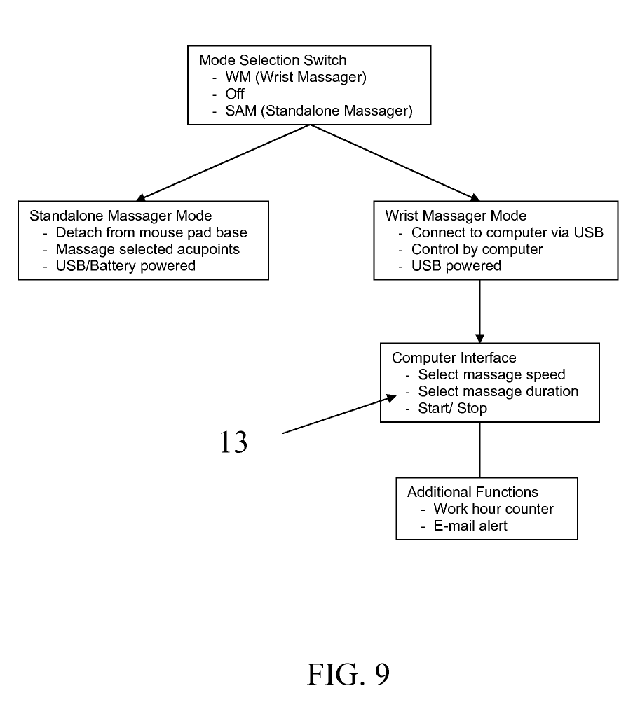

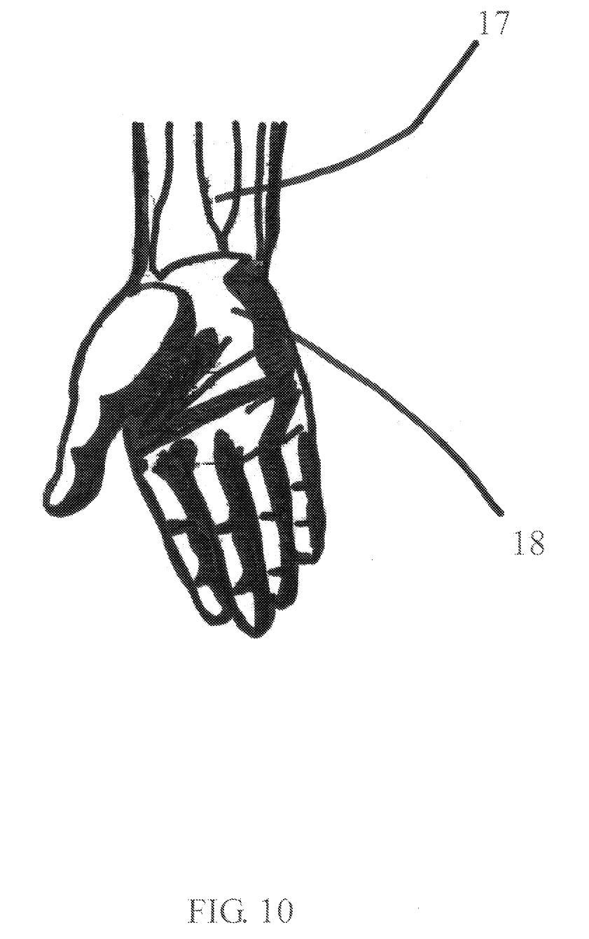

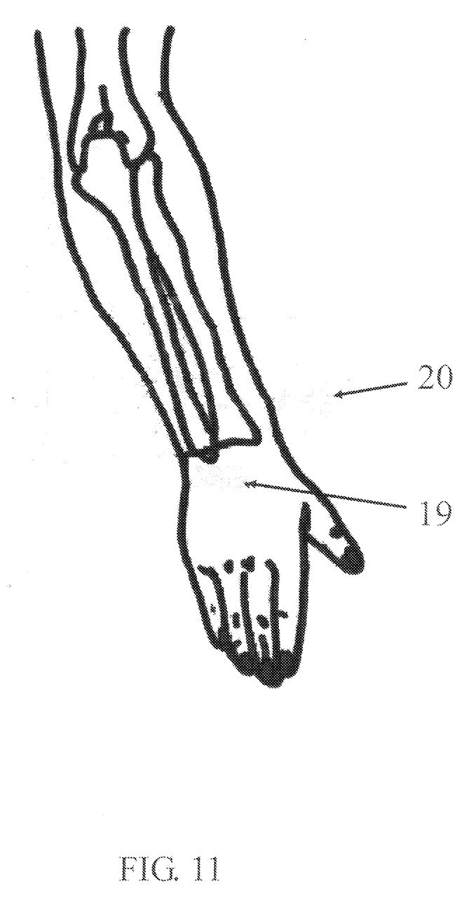

FIG. 9 illustrates the operation flow of the alternative embodiment as a mouse pad massager. A software is provided to allow the user to operate the device via a computer interface 13. The device responds to users' instruction on predetermined options, such as on/off, start/stop, speed, massage duration, records and additional functions of work hour counter and email alert. In preferred embodiment, the user may detach the housing 9 carrying massaging means 3 from the plate 8. The power means of the device can be battery or USB powered through a USB cord connecting the computer.

While certain features and embodiments of the present invention have been described, other embodiments of the present invention will be apparent to those skilled in the art from consideration of the specification and practice of the embodiments of the invention disclosed herein. It is intended, therefore, that the specification and examples be considered as exemplary only, and should not be considered restrictive of the scope of the invention, as described and claimed, with a true scope and spirit of the present invention being indicated by the claims and their full scope of equivalents. Further, features and/or variations may be provided in addition to those set forth herein. For example, embodiments of the present invention may be directed to various combinations and sub-combinations of the features described in the detailed description.

1. A wrist massager comprising:
a strap for holding a cushion housing and a control panel on a wrist of a person; said strap being sized and arranged to encircle the wrist and adapted to be secured on the wrist and hold the cushion housing and a control panel to the wrist;
two cushion housings, one said cushion housing having a back side operably engaged with one planar surface of the strap and having a front side defined at partially by a membrane adapted for placement against the wrist volar; and the other said cushion housing having a back side operably engaged with one planar surface of the strap and having a front side defined at partially by a membrane adapted for placement against the wrist dorsum; and the said cushion housings are fabricated of a compressable and resilient material; each of the said cushion housings further having a hollow cavity intercalated between said front and back sides;
massage means, said massage means are provided in the hollow cavity of each of the said cushion housings and to provide acupressure on specified acupoints of the wrist volar, namely Daling, PC7 and Neiguan, PC6 and the other specified acupoints of the wrist dorsum, namely Yangchi, SJ4 and Waiguan, SJ5;
driving means, said driving means is operably coupled with the massage means and is adapted to provide a reciprocating and/or rotary mechanism via a motor; and
a control panel, said control panel placed on a portion of the strap and on the other side of the strap where the one side of the said strap is operably engaged with one of the cushion housing, so that the surface of the said control panel is upwardly facing the user and disposed at the top of the wrist dorsum when the strap closing and forming a loop and encircling around the wrist.

2. The wrist massager in claim 1, wherein the messaging means comprises are four 3-rollers rotation disc; and the rotation discs are operably engaged to the driving means and are disposed in the housing proximate to the membrane and biased towards the membrane creating localized outwardly deformations in the membrane when in contact with each of the said acupoints of the wrist.

3. The wrist massager in claim 1, wherein the messaging means comprises are four cam wheels; and the cam wheels are operably coupled to the driving means and are disposed in the housing proximate to the membrane and biased towards the membrane creating localized outwardly deformations in the membrane when in contact with each of the said acupoints of the wrist.

4. The wrist massager in claim 1, wherein the driving means is a DC powered motor driving the rotation of and reciprocating the massaging means.

5. The wrist massager in claim 1, wherein the driving means is a DC powered motor installed with concentric means and providing vibration of the massaging means.

6. The wrist massager in claim 1, the said control panel comprising an On/Off button to control the power application and a speed button to control the massage speed; the said control panel further comprising a speed button controlling different messaging speeds and a massaging mode button to interchangeably select a specified massage mode of vibration by momentary pressing the said button.

7. The wrist massager in claim 1, further comprises a LCD display module; the said LCD display module is adapted to display time and date with alarm function, digital numeric and alphabetical characters, graphical animations, massager operation status, massager mode selection status, massage speed selection status, massager duration selection status, massage time countdown and massage program selection status.

8. A wrist massager comprising:
a plate for supporting a housing against the wrist volar; said plate being a planar sized and arranged to allow the wrist lying thereon;
a housing, said housing having a back side operably engaged with a planar surface of the plate and having a front side adapted for placement against the wrist volar; and the said housing is fabricated of a hard and resilient material; the said housing further having a hollow cavity intercalated between said front and back sides;
massage means, said massage means are provided in the hollow cavity of the said housing and to protrude from a proximal edge of the top side of the said housing and to provide acupressure on an acupoint on wrist volar, namely Daling, PC7; and
driving means, said driving means is operably coupled with the massage means and is adapted to provide a reciprocating mechanism via a motor.

9. The wrist massager in claim 8, wherein the massaging means is a 3-rollers rotation disc; and the 3-rollers rotation disc is operably coupled to the driving means and protrude from a proximal edge of the front side of the housing and is positioned to provide acupressure at the acupoint on wrist volar, namely Daling, PC7.

10. The wrist massager in claim 8, wherein the messaging means is a cam wheel; and the cam wheel is operably coupled to the driving means and is disposed at and protrudes from a proximal edge of the front side of the said housing and is positioned to provide acupressure at the acupoint on wrist volar, namely Daling, PC7.

11. The wrist massager in claim 8, wherein the driving means is a powered motor driving the rotation of and reciprocating the massaging means.

12. The wrist massager in claim 8, wherein the driving means is a powered motor installed with concentric means and providing vibration of the massaging means.

13. The wrist massager in claim 8, the said control means comprising a computer program controlling On/Off power application, the massage speed and duration and records; the said computer program is adapted to further provide work hour counter and email alert.

14. The wrist massager in claim 8, the said plate further comprising two flanges each having a dome shape suitably sized for fitting a wrist of a person, the said flanges having a distance in between and are adapted to suitably fit the said housing and a wrist of an user resting on the said housing; the said flanges each having a bottom section statically and directly conjoined to the said surface of the said plate.

15. The wrist massager in claim 8, the said housing is detachable from the said plate.

16. The wrist massager in claim 8, the said housing further comprises a strap operably engaged with the lateral sides of the said housing; the said strap is adapted to hold the said housing to the wrist of an user.

17. The wrist massager in claim 8, the driving means is DC powered or USB powered with a cord connecting a computer and the driving means.
